(19) United States
(12) Patent Application Publication
(10) Pub. No.: US 2010/0290455 A1
(43) Pub. Date: Nov. 18, 2010

(54) METHOD AND APPARATUS FOR COMMUNICATION REQUEST TERMINATION ROUTING

(75) Inventors: John Erickson, Freehold, NJ (US); Daniel Grisinger, Freehold, NJ (US); Michael South, Jackson, NJ (US); Pasquale Villani, Freehold, NJ (US); Chakrapani Gorrepati, Morganville, NJ (US)

Correspondence Address: MOSER IP LAW GROUP / VONAGE, 1030 BROAD STREET, SUITE 203, SHREWSBURY, NJ, 07702, US

(73) Assignee: VONAGE NETWORK LLC., Holmdel, NJ (US)

(21) Appl. No.: 12/779,489

(22) Filed: May 13, 2010

Related U.S. Application Data
(60) Provisional application No. 61/178,007, filed on May 13, 2009.

(51) Int. Cl. H04L 12/66

(52) U.S. Cl. 370/352

(57) ABSTRACT

A method and apparatus for call termination routing. The method comprises determining one or more characteristics of an incoming call, mapping the one or more characteristics to a termination policy, and routing the incoming call to a communication device. The incoming call is routed to the communication device in accordance with the mapped termination policy. The determining, mapping, and routing steps are performed by a controller computing device as known in the art. The apparatus comprises means for determining one or more characteristics of an incoming call, means for mapping the one or more characteristics to a termination policy, and means for routing the incoming call to a communication device. The incoming call is routed to the communication device in accordance with the mapped termination policy.

### CROSS-REFERENCE TO RELATED APPLICATIONS

This application claims priority to U.S. Provisional Patent Application Ser. No. 61/178,007, filed May 13, 2009, which is incorporated by reference herein in its entirety.

### FIELD OF THE INVENTION

The invention is related to the field of telecommunication devices and services and more specifically, the invention is directed to a method and apparatus for communication request termination routing.

### BACKGROUND OF THE INVENTION

The Public Switched Telephone Network (PSTN) or Plain Old Telephone Service (POTS) was originally developed as a rudimentary “one to one” communication system. That is, it is best suited for connecting a first caller party to a second callee party based solely upon the identifying information associated with the callee (i.e., a destination or callee telephone number). The inherent structure and signaling capabilities of the PSTN do not easily lend themselves to customization of the behavior of communication requests (e.g., incoming telephone calls, text messages, and the like) to a destination or central location having multiple users. As such, a communication request is typically terminated at a universally accepted endpoint associated with the central location (i.e., the primary telephone in a household) where any one of a plurality of members of the central location can accept the request. As such, requests for a first member of the callee central location (i.e., to Daughter from Boyfriend) may be intercepted by a second member of the callee central location (i.e., Father). Similarly, undesirable requests (i.e., Telemarketer calling in the evening) to the central location may keep the communication line unnecessarily busy or unavailable for a period of time.

In an attempt to fulfill the need of providing communications to multiple users at a single location, the concept of the Private Branch Exchange (PBX) was developed and implemented. In this way, multiple users at a central location were able to make and receive communication requests. However, PBX's are still limited in their capabilities because they add bulk and complexity to the central location (i.e., additional central location switching equipment) without providing a direct connection from the caller to the callee based on a single central location telephone number. Typically, in order to reach a callee at a central location having multiple callees associated therewith, the caller must have knowledge of secondary access information such as a PBX extension number or otherwise access a local directory or operator to assist in completing the communication request to the callee. While it is possible to have a direct connection by dialing a callee's direct number of the PBX, this forces the caller to remember or otherwise populate and maintain an ever growing number of individual telephone numbers in order to reach each of said callees at the central location.

These types of communications systems are expensive to purchase and install and are typically a business solution; thus, do not lend themselves as a solution at the individual consumer level having a household of multiple users of a single telephone line. Such methodology for completing communication requests has become inefficient and cumbersome because it relies solely upon callee or destination information to complete the request. Additionally, such solution provides the callee with no control over the behavior of how requests to the central location are terminated.

Therefore, there is need in the art for improved execution of communication requests by exploiting additional information available about the communication request beyond callee information.

### SUMMARY OF THE INVENTION

Embodiments of the subject invention comprise a method and apparatus for communication request termination routing. According to some embodiments of the subject invention, the method comprises determining one or more characteristics of an incoming communication request, mapping the one or more characteristics to a termination policy, and routing the incoming communication request to a communication device. The incoming communication request is routed to the communication device in accordance with the mapped termination policy. The determining, mapping, and routing steps are performed by a controller computing device as known in the art.

According to some embodiments of the subject invention, the apparatus comprises means for determining one or more characteristics of an incoming communication request, means for mapping the one or more characteristics to a termination policy, and means for routing the incoming communication request to a communication device. The incoming communication request is routed to the communication device in accordance with the mapped termination policy.

### BRIEF DESCRIPTION OF THE DRAWINGS

So that the manner in which the above recited features of the subject invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a series of method steps for performing call termination in a VoIP telecommunication environment in accordance with the subject invention;

FIG. 2 depicts a system level diagram of a network components that interact with each other to perform call termination in a VoIP telecommunication environment in accordance with the subject invention; and

FIG. 3 depicts a schematic diagram of a controller that may be used to practice one or more embodiments of the subject invention; and

FIG. 4 depicts a series of method steps for performing call termination in a VoIP telecommunication environment in accordance with embodiments of the subject invention.

To facilitate understanding, identical reference numerals have been used, where possible, to designate identical elements that are common to the figures.

### DETAILED DESCRIPTION

The subject invention provides for a method of communication request (i.e., telephone call) processing that does not rely solely on callee information to route the call to a particular terminal. The additional information may include, but is not limited to, information derivable about the caller's identification and the time of day the request is placed. By introducing this additional information into the communication request processing, it is possible to have callers reach multiple users or callees associated with a central location or destination without having to provide additional information about the callee. In one embodiment, relationships between the caller and callee are predefined and stored for future reference. Upon initiation of a communication request, a determination is made as to the existence of a relationship between the caller and callee. The terms “caller” and “callee” are used generally to designate the initiator and recipient of the communication request, respectively. While exemplary embodiments are discussed with respect to telephone calls, one of ordinary skill in the art would recognize the applicability of the present invention to various other types of communication requests. Based on such relationship information, specific instructions for communication request termination (or call flow) are executed so that communication request behavior is tailored to the specific individual associated with the central location.

These types of communication requests are executed using VoIP. Voice over IP (VoIP) is a technological development in the field of telecommunications that is utilized to transmit voice conversations over a data network using Internet Protocol (IP) communications. Entities (either businesses or individuals) use VoIP by purchasing and installing a minimal amount of equipment (a Customer Premise Equipment (CPE) device) to access a VoIP service provider. The VoIP service provider then provides telecommunication service to the entities via a subscription model. After the VoIP service has been subscribed to, and depending on the level of service requested, an entity can make phone calls to other VoIP subscribers or to PSTN customers and access a number of features associated with the VoIP service. As part of the call processing is conducted by non-traditional means (i.e. over a packet-based or VoIP network), signaling and call set up is not performed exclusively by the traditional means governed by ISDN and POTS. In some embodiments, signaling that is conducted in the packet-based network(s) is executed using Session Initiation Protocol (SIP). SIP is a popular communication protocol for initiating, managing and terminating media (e.g., voice, data and video) sessions across packet based networks that typically use the Internet Protocol (IP) of which VoIP is an example. As such, there is increased flexibility in the manner in which requests can be executed and increased features for the customer using VoIP. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. SIP uses a location-independent address system feature in which called parties can be reached based on a party's name. SIP also supports name mapping and redirection allowing users to initiate and receive communication from any location.

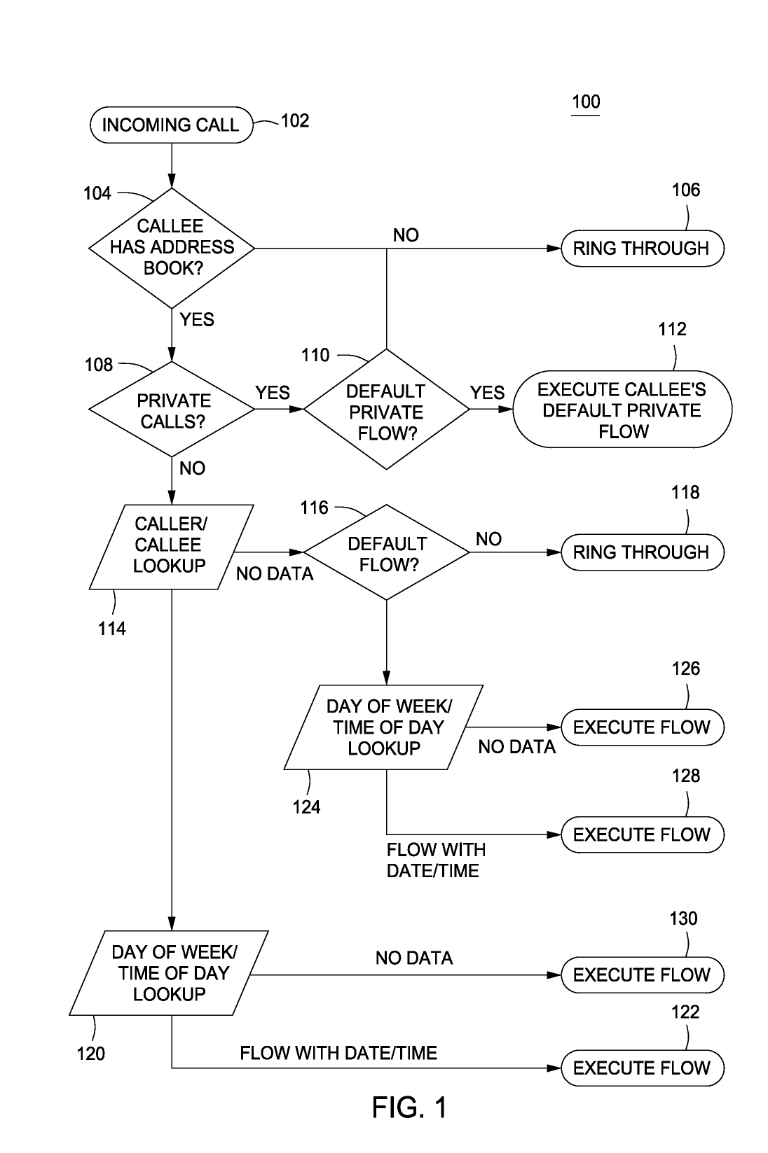

FIG. 1 depicts a series of method steps 100 for practicing communication request termination for a multiuser location in accordance with embodiments of the subject invention. The method 100 begins at step 102 whereby an incoming communication request by a caller to a callee is received. The callee is one of a multiple number of users or callees associated with a central location. In some embodiments, the communication request is a telephone call; however, in some embodiments various types of messaging are also capable of being processed in the method 100 described, such as Short Messaging Service (SMS) or text messages, email, voicemail and the like.

After the request is received, a determination is made at step 104 as to whether the callee that is trying to be reached via the request has a caller information listing (i.e., address book) that is associated with or otherwise maintained by the callee's communication service provider. The address book serves as a main repository of information about callers that the callee has established prior relationships. Information may include name, residential location and one or more telephone numbers or messaging contact identifiers (i.e., email address, chat ID and the like). Additionally, the address book has communication request policy information that governs how communication requests from callers are to be executed. The policy information may include, but is not limited to, time when requests may be sent directly to the callee vs. sent to a secondary location such as a messaging service, a callee whitelist or blacklist designation signifying that the caller is always or never permitted to have requests fulfilled and the like. The time policy may be further refined to denote different policies selected from the group consisting of the time of day and the time of the week when requests are made. If the callee does not have a caller information listing, then the method 100 proceeds to step 106 whereby normal communication request processing occurs by having the request passed to the callee (i.e., “ring through”) without any specific policies on call behavior being invoked. This has the effect of the request being terminated at a universally accepted endpoint associated with the central location (i.e., the primary telephone in a household) where any one of a plurality of members of the central location can accept the request.

If the callee does have a caller information listing, then the method 100 proceeds to step 108 whereby a determination is made as to whether the incoming request has been marked as a private request. A private request would be one that does not specifically identify the caller (i.e., the caller has invoked a blocking function of his information during the request process). As such, this may effect how the callee desires to terminate the request. If the request is identified as private, the method 100 proceeds to step 110 whereby a determination is made as to whether the callee has a preferred private call termination behavior predefined. If there is no such predefined or default private call termination behavior, processing continues by having the request passed to the callee (i.e., “ring through”) at step 106 without any specific policies on call behavior being invoked. If there is a predefined or default private call termination behavior, processing continues by executing the callee's default private call termination behavior at step 112. The default private call termination behavior in one embodiment is selected from the group consisting of “immediately send to voicemail” and “immediately decline request with corresponding message to caller”. Other types of termination behavior are possible based upon callee preferences and are within the scope of the invention.

If the request is not identified as private, the method 100 proceeds to step 114 whereby an information lookup is performed. In one embodiment of the invention, a lookup is performed to determine if a data exists that defines a relationship or desired behavior for communication request termination between the caller and callee. Preferably the data is a subset of data (i.e., data store) that identifies basic callee information, callee address book information and specific caller policy information although additional information may also be used such as timestamps at the time the lookup is performed. In one embodiment of the invention, there is one data store record for each caller that the callee desires to have a specific communication request termination policy. Each data store record is maintained and updated on a regular basis such that at the time of an incoming communication request, the data store record of a particular caller is easily and efficiently retrieved so that a corresponding termination policy can be quickly invoked. If there is no such data store record for the incoming communication request from the particular callee, the method proceeds to step 116 whereby a determination is made as to whether there is a general default termination behavior by which all requests made to the callee are governed. For example, where there is no specific callee termination policy but the caller has a general policy that all incoming calls are forwarded to another telephone number, the callee would be directed to such forwarding number. If no such general default termination behavior is indicated, processing continues by having the request passed to the callee (i.e., “ring through”) at step 118 without any specific policies on call behavior being invoked. If there is a general default termination behavior, processing continues by a time policy lookup is performed at step 124. The time policy lookup further refines the behavior of the general default termination behavior based on the time of day and time of the week that the incoming call request is made. If there is no such time policy data, the method proceeds to step 126 whereby the general default termination behavior is invoked regardless of the time of the request. If there is time policy data, the method proceeds to step 128 whereby the general default termination behavior is invoked based on the time of the request.

If there is a data store record for the incoming communication request from the particular callee, the method proceeds to step 120 whereby a time policy lookup is performed. The time lookup further refines the behavior of the callee request based on the time of day and time of the week that such request is made. If there is no such time policy, the method proceeds to step 130 whereby the callee request is performed regardless of the time of the request. Although for the purposes of the present exemplary embodiment, the time policy lookup step 120 is described as occurring after the caller/callee lookup step 114, one of ordinary skill in the art would recognize that the sequential order of the lookup steps could be altered to result in a different termination policy. For example, a user may wish all calls received after 10:00 pm to go immediately to voicemail, with voicemail box routing occurring based upon a caller/callee lookup 114. In some embodiments the private call check step 108 may also be performed out of the sequence described with respect to the instant example. If there is time policy data, the method proceeds to step 122 whereby the callee request is performed based on the time of the request. Other types of termination behavior are possible based upon callee preferences, time of day/week, messaging preferences and the like and are within the scope of the invention. In one embodiment, the communication request is messaging other than a telephone call and is selected from the group consisting of email, chat sessions, Instant Messaging, and SMS. The method ends by either execution of one of the call flows 112, 122, 126, 128 and 130 or ring through steps 106 and 118.

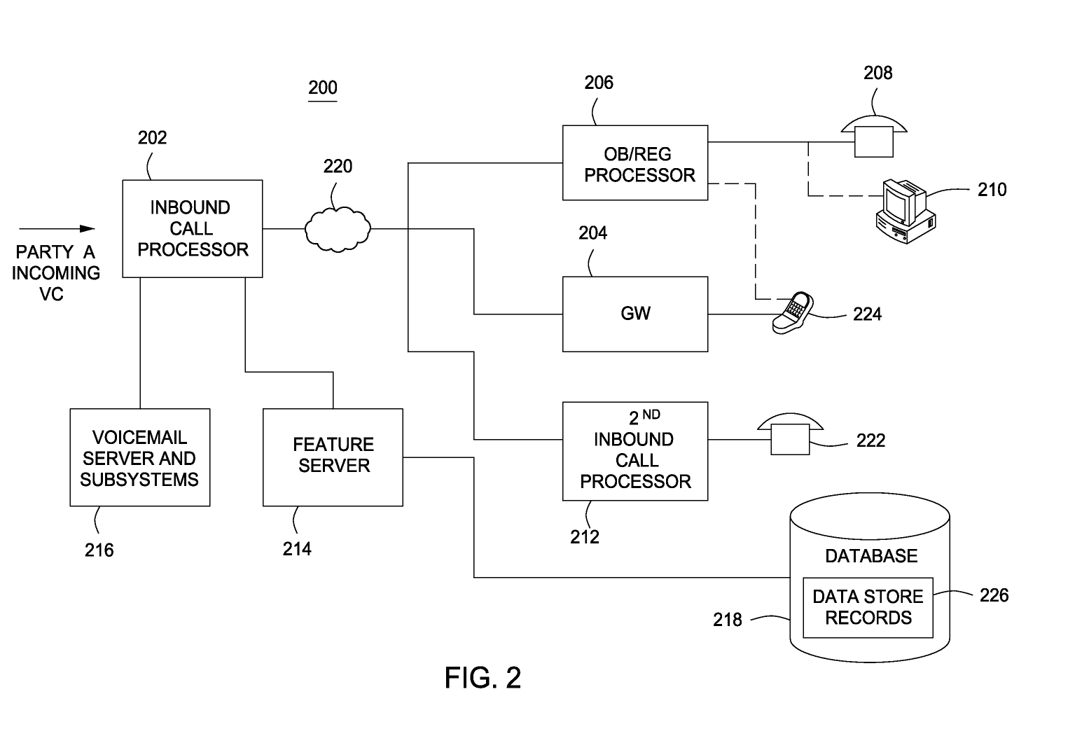

FIG. 2 depicts a system 200 comprised of network components that interact with each other to perform call termination at a multiuser location in a VoIP telecommunication environment in accordance with embodiments of the subject invention. The system 200 comprises an inbound voice communication processor (IB) 202 that receives communication requests from a caller (regardless of PSTN or VoIP originating) and executes the necessary steps to establish a link between the caller and a callee communication device (e.g., a CPE device). Connected to the inbound voice communication processor 202 is a feature server 214. The feature server 214 performs the analysis of caller and callee information, as described above in accordance with the method 100 and in greater detail below. Once the analysis is complete, the feature server 214 generates the appropriate communication request flow to complete the communication request. One or more databases/storage devices 218 that contain information regarding a plurality of network users is connected to the feature server 214. An example of a suitable database/storage device 218 is a MYSQL database on a Linux operating system. The information obtained from the database 218 facilitates voice communication processing functions such as those described earlier and in greater detail below. In one embodiment of the invention, the database 218 holds a collection of XML files containing network user profiles and preferences regarding telecommunication services provided thereon.

The system further includes one or more subsystems connected to the inbound voice communication processor 202 to enable various call handling features. For example, a voicemail server and attendant subsystems 216 are connected to the inbound voice communication processor 202. The voicemail server 216 provides functionality to a voicemail feature when the calling party is given an option to respond or otherwise leave a message for the called party. In some embodiments, the voicemail server 216 incorporates multiple server subsystems to provide robustness, scale and capacity to the system 200 and to allow for different features and continuity of service. Such servers and subsystems are well known in the art and in one example is the ASTERISK PBX system offered by DIGIUM, Inc. of Huntsville, Ala.

While the system as disclosed with respect to FIG. 2 discloses individual servers to perform the various functionality related to call termination and routing, one of ordinary skill in the art would recognize that the roles of the IB 202, feature server 214, voicemail server 216, outbound communication processor 206, and the like could be performed by one or more servers or clusters of servers responsible for a single role, multiple roles, or any such combination thereof. For example, a single server might be responsible for the role of the feature server 214 and the voicemail server 216.

Various components are connected to the inbound voice communication processor 202 via a public/private data network 220 such as but not limited to the Internet. An outbound voice communication/registration processor (OB) 206 conducts various functions for the called party devices including but not limited to maintaining their registration on the system 200. Although the outbound voice communication/registration processor 206 is represented as a single network element in FIG. 2, this depiction may also be representative of a plurality of processors capable of performing identical functions as described in this disclosure for the purposes of redundancy in failover conditions of one or more of such processors. In some embodiments of the invention, the outbound voice communication/registration processor 206 is a plurality of processors acting as a proxy group for a given customer account of a VoIP telephony system. In some embodiments, the outbound voice communication/registration processor 206 is further coupled to a PSTN device 224. For example, a mobile phone PSTN device 224 may possess the capability of receiving a SMS message directly from VoIP service provider operating system 200, rather than via the PSTN network as provided by a gateway 204. Should the PSTN device 224 not be available to receive the SMS message, a Store and Forward operation is performed by a server and subsystems similar in functionality to Voicemail Servicer and Subsystems 216. Accordingly, the next time the PSTN device 224 is available, the SMS will be forwarded from its stored location on such a server. In some embodiments of the invention, the IB 202 may route to a second IB 212 via the network 220. In this manner the subject invention may be implemented in a recursive manner, with separate routing and/or termination policies applied at each level. In some embodiments, the second IB 212 may route to an associated second CPE 208.

The outbound voice communication/registration processor 206 is connected to the CPE device 208 that a called party operates when accessing the communication network 200. Examples of the CPE device 208 include an analog telephone adapter (ATA) and a voice communication device. One specific, non-limiting example of an ATA is modem model no. VT-2442 manufactured and sold by Motorola, Inc. of Schaumburg, Ill. The voice communication device is the physical component that the caller actually interfaces with when involved in a voice communication session. In one embodiment of the invention, the voice communication device is selected from the group consisting of an analog telephone and an IP phone (having the ATA integrated therewithin). Alternately, the voice communication device is a web-based or “softphone” type of device that operates on a PC with integrated audio transducer devices. Specific, non-limiting examples of such voice communication devices that can exploit the advantages of the subject invention include model no. 2500 analog telephone manufactured and sold by CORTELCO of Corinth, Miss., model no. UIP1869V IP telephone manufactured and sold by UNIDEN of Tokyo, Japan, and the V-phone manufactured and sold by Vonage Holdings Corp of Holmdel, N.J. In some embodiments, such devices incorporate the functionality of the ATA and voice communication device in a single component.

The Feature server 214 provides the supporting infrastructure to execute communication request processing in the manner described and in accordance with the subject invention. In particular, the feature server 214 is capable of storing the data store records 226 of a particular callee (e.g., communication service subscriber) such that when a communication request is received at the IB 202, a determination of the existence of the caller information listing (address book) and data store records 226 governing call termination policy is quickly and easily assessed.

The data store records 226 are a subset of general subscriber data which is stored in the database 218. The connection between the database 218 and the feature server 214 allows for periodic updating of the data store records 226 based on subscriber data. For example, if a subscriber changes a particular feature or call termination policy (e.g., via a web-based interface), those changes are made to the subscriber data and updates are sent to the feature server 214 so that corresponding data store records 226 are updated. In some embodiments, the data store records 226 are stored in a data table mapping certain call characteristics (e.g. caller identity, time of day, day of the week, and the like) to a particular termination policy.

Once the relevant information is retrieved, the feature server 214 generates the appropriate communication request flow in accordance with the determined call termination policy and passes such instructions to the IB 202. The IB 202 will then determine the next appropriate point in the communication network so as to terminate the request in the desired manner. As such, the subject invention allows a destination to be a central point of contact for a set of alternate destinations based on a set of rules stored in a database within the communication network. By way of non-limiting example, one or more of the following plurality of call flows may then occur:
a call flow to a gateway 204 that is proximate a PSTN device 224 associated with one of the users associated with the central location (i.e., a cell phone belonging to a member of the household corresponding to the central location, yet having a different DID number than the central location),
a call flow to an OB 206 that is proximate an IP device associated with one of the users associated with the central location (i.e., a softphone client or other IP telephony device belonging to a member of the household corresponding to the central location yet having a different DID number than the central location),
a call flow to a second IB 212 to effect a call feature (i.e., Call Forwarding) policy, and
a call flow to the voicemail server 216 to effect a voice messaging policy. Other call flows are possible based on policy parameters and are within the scope of the invention.

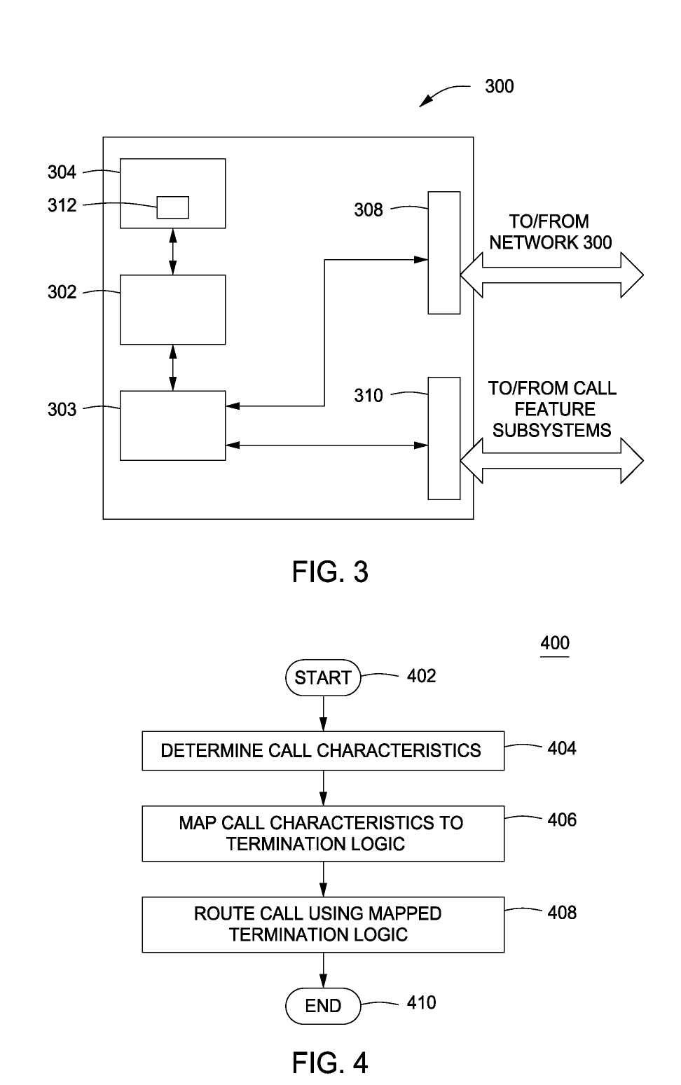

FIG. 3 depicts a schematic diagram of a controller that may be used to practice one or more embodiments of the subject invention. Any one, combination or all of the servers identified in the above Figures and discussed herein can function as a controller 300 that may be used to practice the subject invention. Alternately and preferably, the user access device 102 can also function as a controller for performing the call processing in the manner described. The details of such a device are depicted in FIG. 3 as controller 300.

The controller 300 may be one of any form of a general purpose computer processor used in accessing an IP-based network such as the LAN/WAN presented above, a corporate intranet, the Internet or the like. The controller 300 comprises a central processing unit (CPU) 302, a memory 304, and support circuits 303 for the CPU 302. The controller 300 also includes provisions 308/310 for connecting the controller 300 to databases, customer equipment and/or service provider agent equipment and the one or more input/output devices (not shown) for accessing the controller 300 and/or performing ancillary or administrative functions related thereto. Note that the provisions 308/310 are shown as separate bus structures in FIG. 3; however, they may alternately be a single bus structure without degrading or otherwise changing the intended operability of the controller 300 or invention in general. Additionally, the controller 300 and its operating components and programming as described in detail below are shown as a single entity; however, the controller may also be one or more controllers and programming modules interspersed around a system each carrying out a specific or dedicated portion of the name translation process. By way of non-limiting example, a portion of the controller 300 or software operations may occur at the feature server 214. Other configurations of the controller and controller programming are known and understood by those skilled in the art.

The memory 304 is coupled to the CPU 302. The memory 303, or computer-readable medium, may be one or more of readily available memory such as random access memory (RAM), read only memory (ROM), floppy disk, hard disk, flash memory or any other form of digital storage, local or remote. The support circuits 303 are coupled to the CPU 302 for supporting the processor in a conventional manner. These circuits include cache, power supplies, clock circuits, input/output circuitry and subsystems, and the like. A software routine 312, when executed by the CPU 302, causes the controller 300 to perform processes of the subject invention and is generally stored in the memory 304. The software routine 312 may also be stored and/or executed by a second CPU (not shown) that is remotely located from the hardware being controlled by the CPU 302.

The software routine 312 is executed to determine and perform a termination policy for incoming calls. The software routine 312, when executed by the CPU 302, transforms the general purpose computer into a specific purpose computer (controller) 300 that controls the communication request termination process of, for example, FIG. 1. Although the process of the subject invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 312 of the subject invention is capable of being executed on computer operating systems including but not limited to MICROSOFT WINDOWS 98, MICROSOFT WINDOWS XP, APPLE OS X and LINUX. Similarly, the software routine 312 of the subject invention is capable of being performed using CPU architectures including but not limited to APPLE POWER PC, INTEL X83, SUN service provider AGENTRC and INTEL ARM.

FIG. 4 depicts a series of method steps 400 for routing call termination in accordance with embodiments of the subject invention. In some embodiments of the subject invention, the method 400 is executed by the controller 300 to provide call termination routing functionality. The method begins at step 402 whereby an incoming call is received. At step 404, the method determines one or more characteristics from the incoming call, such as the caller's location, the caller's identity, the time of day the call is placed, the day of the week the call is placed, and the like. Once the characteristics of the call have been determined, the method proceeds to step 406.

At step 406, the method maps the determined call characteristics to a termination policy. In some embodiments, the method determines a termination policy in accordance with the caller identity and the date/time, such as by the method discussed above with respect to FIG. 1. In some embodiments, the method determines the termination policy by performing a table lookup of the set of call characteristics, where each set of call characteristics is mapped to a specific termination policy. In some embodiments, the mapping table is derived from a set of address book information as discussed with respect to FIG. 1. Once a termination policy has been determined (e.g., the call should be routed to a specific voicemail box because the caller number is private, or the call should be routed to a particular phone because the caller is a particular person calling at a particular time of day), the method proceeds to step 408.

At step 408, the method routes the incoming call using the mapped termination policy determined during step 406. The method ends at step 410 when the call has been routed in accordance with the termination policy.

While foregoing is directed to embodiments of the subject invention, other and further embodiments of the invention may be devised without departing from the basic scope thereof, and the scope thereof.

1. A method for communication request termination routing in a Voice over Internet Protocol (VoIP) system, the method comprising:
determining one or more characteristics of an incoming communication request using a controller;
mapping the one or more characteristics to a termination policy using the controller; and
routing the incoming communication request to a communication device in accordance with the termination policy using the controller.

2. The method of claim 1, wherein the one or more characteristics comprise at least one of a requester identity, a time of day the incoming communication request is placed, or a day of the week the incoming communication request is placed.

3. The method of claim 1, wherein the one or more characteristics further comprise whether the incoming communication request is from an anonymous requester.

4. The method of claim 3, wherein the termination policy further comprises a default termination policy for anonymous requesters.

5. The method of claim 4, wherein the default termination policy comprises routing an incoming call from an anonymous requester to a voicemail system.

6. The method of claim 1, wherein the communication device is at least one of a group comprising a voicemail system, a home telephone, a cellular phone, a pager, or a personal digital assistant.

7. The method of claim 1, wherein the mapping step further comprises performing a lookup operation on a data table wherein the data table is indexed by one or more values associated with the one or more characteristics, and wherein each of the values is associated with a particular termination policy.

8. The method of claim 7, further comprising determining if a destination number of the incoming communication request has an address book comprising the data table associated therewith.

9. The method of claim 1, wherein the one or more characteristics map to a default termination policy that routes the incoming call to a primary household phone.

10. The method of claim 1, wherein the incoming communication request is a text message.

11. The method of claim 1, wherein the one or more characteristics are defined by the recipient of the communication request.

12. The method of claim 1, wherein the termination policy is selected from a group comprising a default termination policy or a recipient-defined termination policy.

13. The method of claim 1, wherein the termination policy routes the incoming communication request to one or more communication devices chose from a plurality of communication devices.

14. An apparatus for communication request termination routing in a VoIP system, the apparatus comprising:
means for determining one or more characteristics of an incoming communication request;
means for mapping the one or more characteristics to a termination policy; and
means for routing the incoming communication request to a communication device in accordance with the termination policy

15. The apparatus of claim 14, wherein the one or more characteristics comprise at least one of a requester identity, a time of day the incoming communication request is placed, or a day of the week the incoming communication request is placed.

16. The apparatus of claim 14, wherein the communication device is at least one of a group comprising a voicemail system, a home telephone, a cellular phone, a pager, or a personal digital assistant.

17. The apparatus of claim 14, wherein the means for mapping further comprises performing a lookup operation on a data table wherein the data table is indexed by one or more values associated with the one or more characteristics, and wherein each of the values is associated with a particular termination policy.

18. The apparatus of claim 14, wherein the means for determining further comprises determining if the incoming communication request is from an anonymous requester.

19. The apparatus of claim 14, wherein the one or more characteristics map to a default termination policy that routes the incoming communication request to a primary household phone.

20. The apparatus of claim 14, wherein the incoming communication request is a text message.
